(19) United States
(12) Patent Application Publication
(10) Pub. No.: US 2014/0265597 A1
(43) Pub. Date: Sep. 18, 2014

(54) Distributed Energy System Architecture with Thermal Storage

(71) Applicant: Mondre Energy, Inc., Philadelphia, PA (US)

(72) Inventor: Steven F. Miller, Wyndmoor, PA (US)

(73) Assignee: Mondre Energy, Inc., Philadelphia, PA (US)

(21) Appl. No.: 14/203,624

(22) Filed: Mar. 11, 2014

Related U.S. Application Data
(60) Provisional application No. 61/776,909, filed on Mar. 12, 2013.

(51) Int. Cl. H02J 3/38

(52) U.S. Cl. CPC H02J 3/381
USPC 307/69

(57) ABSTRACT

In one embodiment, power gathering system (PGS) circuits are connected as an electrical overlay system to a distribution substation of a conventional electric-power generation, transmission, and distribution system. Combined heat and power (CHP) generators generate (i) electric power provided to the PGS circuits and (ii) thermal energy provided to co-located thermal host facilities that also receive electric power from the PGS circuits. The CHP generators convert excess thermal energy not used by the thermal host facilities into additional electric power provided to PGS circuits. As the amount of thermal energy used by the thermal host facilities varies over time, the amount of additional electric power generated by CHP generators is inversely varied. In this way, the primary electric-power generators (e.g., gas turbine generators) of the CHP generators can be operated economically at optimal levels independent of the thermal energy demand of the thermal host facilities.

### CROSS-REFERENCE TO RELATED APPLICATIONS

This application claims the benefit of the filing date of U.S. provisional application No. 61/776,909, filed on Mar. 12, 2013, the teachings of which are incorporated herein by reference in their entirety.

### BACKGROUND

1. Field of the Invention

The present invention relates to power generation, transmission, and distribution and, more particularly, to the generation and conveyance of electric power, the recovery and storage of thermal energy, and the conversion of thermal energy into electric power.

2. Description of the Related Art

This section introduces aspects that may help facilitate a better understanding of the invention. Accordingly, the statements of this section are to be read in this light and are not to be understood as admissions about what is prior art or what is not prior art.

Large central generating plants that use coal, natural gas, oil, or nuclear fuel are used in electric power systems throughout the industry in the U.S. and abroad. Generating capacities of central generating plants range from about 25 Mw to over 1,000 Mw. Central generating plants are typically located remote from end-use facilities and typically convert less than 40 percent of the energy content of fuel into electric power. A key feature of the existing power transmission and distribution system is that it is designed for power flow in only one direction: from central generating plants to the electric transmission system, to distribution substations, and then radially outward to end-use facilities.

Distributed generation, by contrast, refers to a variety of smaller power-generating technologies that are installed at or near end-use facilities. Distributed generation technologies include wind turbines, solar photo-voltaic panels, fuel cell generators, gas turbine generators, and reciprocating engine generators. Distributed generation units typically have 25 Mw or less in generating capacity.

A combined heat and power (“CHP”) generator is a type of distributed generation system that is commonly comprised of one or more gas turbine generators or reciprocating engine generators that convert a fuel, typically natural gas, into electric power and waste heat, which is also referred to as “thermal energy”. The financial feasibility of CHP generator operation is heavily dependent on the extent to which the waste heat can be beneficially utilized in an end-use facility such as for space heating or domestic water heating or industrial process heating. When waste heat can be fully utilized, power from a CHP unit can be produced at less than half of the cost of power generated by central plants that use coal, natural gas, or oil as fuel.

Conventional CHP generator year-round operation with total waste-heat utilization at full power output is currently practical only in instances where the end-use facility's year-round heat and power demand exceeds the CHP generator's maximum heat and power output. Such instances are limited to industrial plants or commercial buildings with significant year-round domestic water heating, laundry, and food service heat demand such as large hospitals or hotels. In practically all other types of commercial buildings, heat demand results almost entirely from winter space heating requirements with minimal heat demand at other times of the year. Limited heat demand renders CHP generator operation economically unattractive for the majority of commercial buildings at all times of year except during the winter months when space heat demand provides a beneficial use for CHP waste heat.

Current practice by those skilled in the art is to electrically interconnect distributed generation systems on the customer side of the electric meter so that power generated would replace power delivered by an electric utility. If the distributed generation system produces more power than the end-use facility consumes, power will flow in reverse into the electric distribution system. When this occurs, unstable voltage conditions could be experienced in some areas of the electric distribution system that could adversely impact operation of some types of electrically operated equipment in end-use facilities that are electrically interconnected to the same circuit. In addition, the electric utility would have difficulty ascertaining the direction of power flow in circuits where distributed generators are connected. This could potentially expose workers to harmful power flows when distribution system repairs must be made on these circuits. Electric utilities typically restrict distributed generation owners from producing power in excess of their use in order to prevent export of excess power into the distribution system which can burden the economics of distributed generation to such an extent that investment in distributed generation becomes unattractive and CHP economic feasibility is restricted to industrial and commercial facilities with year-round heat demand.

### BRIEF DESCRIPTION OF THE DRAWINGS

Other embodiments of the invention will become more fully apparent from the following detailed description, the appended claims, and the accompanying drawings in which like reference numerals identify similar or identical elements.

FIG. 1 is a schematic representation of the basic architecture of an existing electric power generation, transmission, and distribution (GTD) system. The outward radial power flow from a distribution substation to a plurality of electric end-use facilities reflects current art for all electric power distribution systems in use throughout the electric utility industry in the U.S. and abroad.

FIG. 2 is a schematic representation of the basic architecture of an exemplary, novel Power Gathering System (“PGS”) that aggregates electricity generated by eight CHP generators at widely separated locations and conveys this electricity radially inward, directly supplying a select subset of electric end-use facilities with power and terminating at a distribution substation, where any remaining power is conveyed to the electric end-use facilities that are interconnected with the conventional electric distribution system.

FIG. 3 is a diagram illustrating the elements of the Waste Heat Recovery and Conversion System for a conventional gas turbine electric generator. Novel components of the system include the High-Temperature Heat Conversion system and the Low-Temperature Heat Conversion system.

FIG. 4 is a diagram illustrating the manner in which the Waste Heat Conversion System interfaces with the jacket water cooling system and the exhaust heat recovery silencer of a conventional reciprocating engine generator.

FIG. 5 depicts the components of a conventional organic Rankine cycle (“ORC”) generator that is a component the High Temperature Heat Conversion, Low Temperature Heat Conversion, and Waste Heat Conversion systems in FIGS. 3, 4, 6, 7, and 8.

FIG. 6 is a schematic diagram of a High-Temperature Heat Conversion System that illustrates a novel design for an apparatus that recovers heat from the exhaust of a gas turbine generator and that simultaneously produces electricity and steam at two pressure levels.

FIG. 7 is a schematic diagram of a Low-Temperature Heat Conversion System that illustrates a novel design for an apparatus to convert waste heat recovered from the exhaust of a gas turbine generator by conventional means into electricity that can be generated at a controlled variable rate, while the gas turbine generator produces power at a constant rate.

FIG. 8 is a schematic diagram of Waste Heat Conversion System that illustrates a novel design for an apparatus to convert waste heat recovered from a conventional reciprocating engine generator by conventional means into electricity that can be produced at a controlled variable rate, while the reciprocating engine generator produces power at a constant rate.

### DETAILED DESCRIPTION

One embodiment of the disclosure is a novel Distributed Heat and Power System (DHPS) architecture that (1) improves the operating efficiency of combined heat and power (“CHP”) generators and that (2) prevents unstable voltage conditions and safety concerns that arise when large numbers of distributed power generators are interconnected with electric distribution systems that represent current art. An exemplary DHPS architecture disclosed herein has (at least) two novel features: (1) a Waste Heat Recovery and Conversion System that captures substantially all of the recoverable waste heat that is rejected from one or more CHP generators and that converts said waste heat into electric power and thermal energy that can be beneficially utilized and (2) a Power Gathering System that transports power produced by a plurality of CHP power generators located at widely separated sites for the purpose of delivering their aggregate power output to the electric transmission system, at a single point of interconnection, using conventional means of electric power conveyance. The Power Gathering System operates independently and separate from utility-operated electric distribution systems. It is understood by those skilled in the art that CHP generators typically cannot operate cost-effectively during the summer months when there is no significant demand for space heating, and opportunities for other beneficial uses of waste heat in most commercial facilities are limited. CHP generators that are equipped with the Waste Heat Recovery and Conversion System disclosed herein and that are interconnected with the Power Gathering System disclosed herein would be capable of operating year-round at full power output with maximum efficiency thereby making it economically feasible for such CHP generators to serve as a financially viable alternative to central generating plants that represent current art and that use coal, natural gas, oil, or nuclear fuel.

The Power Gathering System (“PGS”) gathers power produced by a plurality of CHP generators located at widely separated sites for the purpose of conveying their aggregated power output to an electric distribution substation without directly interconnecting with an existing, electric distribution system. The aggregated power output of the CHP generators supplants power that would otherwise have been supplied by central generating plants to electric loads interconnected with an electric distribution system operated by an electric distribution utility. CHP generators are typically installed within the property boundary (the “Site Boundary”) of the end-use facility that utilizes waste heat produced by the CHP generator (“Thermal Host Facility”). The Thermal Host is also electrically interconnected with the PGS and is supplied by the aggregated power output of the CHP generators. End-use facilities that are not Thermal Host Facilities but that are interconnected with the PGS (“Offsite Electric Loads”) are also supplied by the aggregated power output of the CHP generators. The amount of power collectively produced by the CHP generators that is in excess of the power consumed by the Thermal Hosts, the Offsite Electric Loads, and the electric load interconnected with the existing electric distribution system flows into the electric transmission system supplanting power produced by central generating plants.

The Waste Heat Recovery and Conversion System captures waste heat from a conventional gas turbine generator or reciprocating engine generator and converts said waste heat into electric power, steam, and/or hot water.

The PGS and the Waste Heat Recovery and Conversion System, when used together, allow CHP generators to operate continuously at full power output with maximum efficiency, thereby making it economically feasible for CHP generators to serve as a financially viable alternative to central generating plants that represent current art and that use coal, natural gas, oil, or nuclear fuel.

FIG. 1 is a schematic representation of the basic architecture of current art for electric power generation, transmission, and distribution. Electricity is produced at low voltage, e.g., 13 kV in this illustration, by a plurality of central generating plants. The central generating plant 1′ is one such plant. A transformer T1′ is used to increase the voltage of the power produced by the central generating plant 1′ to transmission level which typically ranges from 115 kV to 765 kV. The power is then conveyed at elevated voltage via the electric transmission system 2′ and 3′ to a plurality of distribution substations, where the voltage is reduced to distribution level which typically ranges from 480V to 33 kV. The distribution substation 4′ is one such distribution substation. The power then is conveyed at distribution-level voltage via a plurality of electric distribution circuits 5′, 6′, 7′, and 8′ that extend radially outward to interconnect with numerous electric end-use facilities 9′ located over a wide area.

FIG. 2 is a schematic representation of the Power Gathering System (“PGS”) that illustrates the manner in which electricity generated by eight CHP generators, CHP-1 through CHP-8, is conveyed radially inward via the PGS circuits 11, 12, 13, and 14 to an analogous distribution substation 4 at a single point of interconnection 10. Each CHP generator is installed within the Site Boundary of a Thermal Host Facility, H1 through H8, in order to minimize the cost of installing piping needed to convey waste heat in the form of steam or hot water to each Thermal Host Facility. FIG. 2 also shows four electric end-use facilities that are not Thermal Hosts that have migrated from the conventional electric distribution circuits and receive electric power via the PGS. These facilities are designated as “Offsite Facilities”, OS1 through OS4, which describes their location outside of the Site Boundary of each Thermal Host Facility. The PGS operates independently from conventional electric distribution circuits 5, 6, 7, and 8, which operate supplying power to end-use facilities that have not migrated to the PGS. Electricity needed to meet the collective power demand of the eight Thermal Host Facilities and the four Offsite Facilities is supplied by the eight CHP generators via the PGS, which supplants electric power produced by central generating plants. Electricity produced by the eight CHP generators that exceeds the amount consumed by the eight Thermal Host Facilities, the four Offsite Facilities, and the electric end-use facilities that remain interconnected with conventional electric distribution circuits 5, 6, 7 and 8 is conveyed into the electric transmission system 2 and 3, further supplanting power produced by central generating plants.

FIG. 3 is a diagram illustrating the elements of the Waste Heat Recovery and Conversion systems configured for use with a conventional gas turbine electric generator GT-1 which is comprised of a High-Temperature Heat Recovery and Conversion section and a Low-Temperature Heat Recovery and Conversion section. In this exemplary embodiment, the gas turbine generator GT-1 uses natural gas 15 as fuel and operates at constant, maximum power output 16, which is conveyed to the PGS by conventional means. Gas turbine exhaust 17 flows at temperatures that typically range from 700 Deg. F. to over 1,000 Deg. F. depending on the design of the gas turbine generator.

Heat-transfer fluid is circulated by pump P-1A through coils in the High-Temperature Waste Heat Recovery unit E-1A, which heat-transfer fluid absorbs a portion of the heat in the gas turbine exhaust. The High-Temperature Heat Conversion System (“HTHC”) uses the heat absorbed by the heat-transfer fluid 19 to produce high-pressure steam 21 and low-pressure steam 22 for use in a Thermal Host Facility. The cooled heat-transfer fluid 20 is then returned to unit E-1A for reheating. Recovered heat that is not utilized to produce steam is converted in the HTHC system into power 24 that is conveyed to electric end-use facilities via the PGS.

The Low-Temperature Heat Recovery and Conversion (“LTHC”) section uses high-pressure water circulated by pump P-1B through coils in the Low-Temperature Heat Recovery unit E-1B, which water absorbs additional heat from the gas turbine exhaust 18 that enters unit E-1B at a temperature of approximately 475 Deg. F. The LTHC system uses the heat absorbed by the circulating high-pressure water 26 to produce hot water 28 for use in a Thermal Host Facility. The cooled high-pressure water 27 is returned to unit E-1B for reheating. Heat that is recovered in unit E-1B that is not utilized to produce hot water is converted in the LTHC system into power 29 that is conveyed to electric end-use facilities via the PGS. The power output from the LTHC system varies in response to an external control signal 30 while generator GT-1 power output 16 remains constant.

FIG. 4 is a diagram illustrating the manner in which the Waste Heat Conversion (“WHC”) system thermally interfaces with a conventional reciprocating engine generator. In this exemplary embodiment, the reciprocating engine generator EG-1 uses natural gas 31 as fuel and operates at constant, maximum power output 32 at all times. The energy content of the natural gas fuel that is not converted to electricity is rejected as waste heat via a jacket water cooling heat exchanger E-1C and an exhaust heat recovery silencer E-1D. Current art is to recover waste heat from a reciprocating engine generator by circulating cooling water 33 through the jacket water cooling heat exchanger E-1C, which water absorbs the rejected heat and raises the cooling water temperature 34 to 185 Deg. F.

Current art is to reject this heat into the atmosphere using a conventional radiator or cooling tower, whereas, in this exemplary embodiment, this heat is converted to power in the WHC system. Pump P-2 circulates cooling water 33 through the jacket water cooling heat exchanger E-1C and through a conventional exhaust heat recovery silencer E-1D, which transfers heat from 950 Deg. F. engine exhaust gas 39 to heat the cooling water to approximately 315 Deg. F. This heated cooling water 35 circulates to the WHC system to produce low-pressure steam 36 for use in a Thermal Host Facility and electricity 38 that is conveyed to other electric end-use facilities via the PGS. The power generated by the WHC system varies in response to an external control signal 37, while generator EG-1 power output 32 remains constant. Pump P-3 conveys a portion 40 of the hot water stream 34 to the Thermal Host Facility 85, which is returned 41 to the cooling water system for reheating.

FIG. 5 depicts the components of a conventional organic Rankine cycle (“ORC”) electric generator that is a component of the HTHC system depicted in FIGS. 3 and 6, the LTHC system depicted in FIGS. 3 and 7, and the WHC system depicted in FIGS. 4 and 8. A thermal fluid 40, such as high-temperature water or a heat-transfer fluid, is pumped through an evaporator EV-1, which contains an organic working fluid, such as isopentane. Heat from the thermal fluid is transferred to the organic working fluid contained in evaporator EV-1 causing the organic working fluid to vaporize. The cooled thermal fluid 41 is returned for reheating by a heat source 39, such as heat transfer fluid 19 of FIG. 3 or high-pressure hot water 26 of FIG. 3 or high-pressure hot water 35 of FIG. 4. An organic vapor turbine N-1 expands the vaporized organic fluid 43, which then enters organic vapor condenser C-1 as expanded organic vapor 44. The organic vapor turbine N-1 drives generator G-1, which produces electricity 45 that is conveyed to electric end-use facilities via the PGS. Condenser C-1 condenses the expanded organic vapor 44 from turbine N-1 and produces condensed organic fluid 42. Pump P-4 returns the condensed organic fluid to the evaporator EV-1 to repeat the evaporation cycle. Pump P-5 circulates cooling water through the condenser C-1 and cooling tower CT-1, which rejects the heat of condensation contained in the organic vapor into the atmosphere.

FIG. 6 is a schematic diagram of the gas turbine HTHC system of FIG. 3 in which heat-transfer fluid (“HTF”) 19 that has been heated to 580 Deg. F. in unit E-1A is pumped via pump P-1A to control valve V-1. Control valve V-1 directs a portion 48 of the HTF 19 to steam generator E-2 in response to the steam pressure measured by pressure controller PC-1. Control valve V-1 modulates HTF 48 flow to steam generator E-2 as needed to maintain steam 53 pressure at approximately 150 psig. The portion 49 of HTF 19 that is not needed to produce steam is directed by control valve V-1 to ORC generator ORC-1, where it serves as high-temperature source fluid for generation of electric power 51, which is conveyed to electric end-use facilities via the PGS 29.

A portion 55 of high-pressure steam 53 is supplied to steam turbine N-2, which reduces the steam's pressure to levels needed to supply low-pressure steam 57 to the Thermal Host Facility. Pressure controller PC-2 measures steam 57 pressure and modulates control valve V-2 as needed to maintain steam 57 pressure at approximately 5 to 10 psig. Steam turbine N-1 drives generator G-2, which produces electricity 56 that is conveyed to electric end-use facilities via the PGS 29.

Pump P-6 is used to convey a portion 58 of HTF 19 to superheater E-3, which transfers heat from HTF 58 to superheat high-pressure steam 59 when heat loss in transit to the Thermal Host Facility is a concern.

Steam condensate 60 that is returned from the Thermal Host Facility and make-up water 61 is conveyed to deaerator D-1, where the oxygen and other non-condensable gases are removed. The combined steam condensate and make-up water flow 52 is then supplied to steam generator E-2 via pump P-5 to generate steam. Cooled HTF 20 from steam generator E-2, superheater E-3, and ORC generator ORC-1 is returned to unit E-1A of FIG. 3 for reheating.

FIG. 7 is a schematic diagram of the gas turbine LTHC system of FIG. 3 in which water 26 that has been heated to 315 Deg. F. in unit E-1B is used as the thermal fluid 63 heat source for each of four organic Rankine generators ORC-2 through ORC-5. The ORC generators are connected in series such that the thermal fluid leaving the evaporator of each preceding ORC generator is used as the thermal fluid for each succeeding ORC generator. The thermal fluid (64, 65, 66, 67) temperature exiting each ORC generator is approximately 30 Deg. F. lower than the thermal fluid (63, 64, 65, 66) temperature entering that ORC generator. The thermal fluid 67 exits the last ORC generator 66 at approximately 195 Deg. F.

The total power output 29 of all four ORC generators can be varied in response to an external control signal 30 by altering the thermal fluid flow rate though the ORC generators. Pump P-7 is a variable-speed pump that is capable of changing thermal fluid flow rate by changing its rotational speed. Power output controller EC-1 processes an external control signal 30 and varies the thermal fluid flow rate by causing the rotational speed of pump P-7 to vary, which in turn causes the aggregate ORC generator power output 29 to vary.

A portion 27 of the thermal fluid 67 leaving ORC generator ORC-5 returns to unit E-1B of FIG. 3 for reheating.

Pump P-1B operates at a constant flow rate, whereas pump P-7 operates at a variable flow rate depending on the level of power output required from the ORC generators. The role of heat accumulator D-2A is to accommodate the differences in flow rate between pumps P-1B and P-7 by accumulating high-temperature thermal fluid 69 when pump P-7 flow rate is less than pump P-1B flow rate. Similarly, heat accumulator D-2A discharges high-temperature thermal fluid 69 when pump P-7 flow rate is greater than pump P-1B flow rate. Heat accumulator D-2A remains full at all times. The gradient between high-temperature thermal fluid 69 at the top of heat accumulator D-2A and low-temperature thermal fluid 70 at the bottom of heat accumulator D-2A changes in response to the difference in flow rate between pumps P-1B and P-7.

Although FIG. 7 shows pump P-7 located between pump P-1B and the input to ORC generator ORC-2 and connected directly to the top of heat accumulator D-2A, in alternative configurations, pump P-7 could be located elsewhere, such between the output of ORC generator ORC-5 and the bottom of heat accumulator D-2A.

FIG. 8 is a schematic diagram of waste heat conversion system WHC of FIG. 4 in which water 35 that has been heated to 315 Deg. F. in heat recovery silencer E-1D is supplied to control valve V-3. Control valve V-3 directs a portion 71 of the heated water 35 to steam generator E-4 in response to the steam 36 pressure measured by pressure controller PC-3. Control valve V-3 modulates heated water 71 flow to steam generator E-4 as needed to maintain steam 36 pressure at approximately 5 to 10 psig. Heated water 70 not needed to produce steam serves as thermal fluid heat source 73 for the first of six organic Rankine generators ORC-6 through ORC-11. The ORC generators are connected in series such that the thermal fluid leaving the evaporator of each preceding ORC generator is used as the thermal fluid for each succeeding ORC generator. The thermal fluid (74, 75, 76, 77, 78, 79) temperature exiting each ORC generator is approximately 27 Deg. F. lower than the thermal fluid (73, 74, 75, 76, 77, 78) temperature entering that ORC generator. The thermal fluid 79 exits the last ORC generator 78 at approximately 155 Deg. F.

The total power output 38 of all six ORC generators can be varied in response to an external control signal 37 by altering the thermal fluid 73 flow rate though the ORC generators. Pump P-8 is a variable-speed pump that is capable of changing thermal fluid 73 flow rate by changing its rotational speed. Power output controller EC-2 responds to the external control signal 37 and varies the thermal fluid 73 flow rate by causing the rotational speed of pump P-8 to vary, which in turn causes the aggregate ORC generator power output 38 to vary.

Thermal fluid 79 leaving ORC generator ORC-11 flows through radiator E-5 and then returns to exchanger E-1C of FIG. 4 for reheating. The fan of radiator E-5 is normally off and functions only when thermal fluid 79 temperature exceeds the maximum inlet temperature to exchanger E-1C.

The sum of thermal fluid 70 flow rate and heated water 71 flow rate equals heated water 35 flow rate. As low-pressure steam production 36 varies, thermal fluid 70 flow rate will vary inversely. Thermal fluid 73 flow also varies with ORC generator power output 38.

The role of heat accumulator D-2B is to accommodate the differences in flow rates of thermal fluids 70 and 73 by accumulating high-temperature thermal fluid 80 when the flow rate of thermal fluid 73 is less than the flow rate of thermal fluid 70. Similarly, heat accumulator D-2B discharges high-temperature thermal fluid 80 when the flow rate of thermal fluid 73 is greater than the flow rate of thermal fluid 70. Heat accumulator D-2B remains full at all times. The gradient between high-temperature thermal fluid 80 at the top of heat accumulator D-2B and low-temperature thermal fluid 81 at the bottom of heat accumulator D-2B changes in response to the difference between in the flow rate of thermal fluid 73 and the flow rate of thermal fluid 70.

Steam condensate 84 that is returned from the Thermal Host Facility and make-up water 83 is conveyed to deaerator D-1A, where the oxygen and other non-condensable gases are removed. The combined steam condensate and make-up water flow 82 is then supplied to steam generator E-4 via pump P-9 to generate steam.

Although FIG. 8 shows pump P-8 located between control valve V-3 and the input to ORC generator ORC-6 and connected directly to the top of heat accumulator D-2B, in alternative configurations, pump P-8 could be located elsewhere, such as between the output of ORC generator ORC-11 and the bottom of heat accumulator D-2B.

The present disclosure has been discussed in the context of FIG. 2, which shows a Power Gathering System (PGS) comprising PGS circuits 11-14 connected as an electrical overlay system to a distribution substation 4 of a conventional electric-power generation, transmission, and distribution (GTD) system, such as that shown in FIG. 1. Although not shown in the figures, the conventional electric-power GTD system could have additional distribution subsystems, each of one or more or possibly all of which could have an analogous PGS system having one or more PGS circuits connected as an electrical overlay system. Depending on the particular implementation, the conventional electric-power GTD system could be an existing system that is retrofitted with the PGS system or it could be a new system initially provisioned with the PGS system.

In general, the PGS circuits of a PGS system could be connected to one or more of the following facilities:
One or more combined heat and power (CHP) generators, such as CHP-1 to CHP-8 of FIG. 2, that supply electric power directly to the PGS system and thermal energy to on-site Thermal Host Facilities, such as H1-H8 of FIG. 2, that use both electric power from the PGS system as well as the thermal energy directly from the CHP generator;
One or more CHP generators (not shown in FIG. 2) that supply electric power to the PGS system, but do not supply thermal energy to any facility;
One or more facilities that are supplied only with electric power from the PGS system, such as off-site facilities OS1-OS4 of FIG. 2. Note that other facilities (not shown in FIG. 2) could be co-located on-site with CHP generators, but not require thermal energy from those CHP generators; and
Non-CHP electric-power generators (not shown in FIG. 2), such as, for example, solar cells or wind generators, that supply electric power to the PGS system but do not generate any thermal energy that is used by other facilities.

FIG. 3 shows a CHP architecture having a gas turbine generator that functions as a primary electric power generator and two heat recovery and conversion stages: (i) a first, high-temperature stage that converts some of the thermal energy received from the primary generator exhaust into a first amount of additional electric power and (ii) a second, low-temperature stage that converts some of the thermal energy received from the high-temperature stage into a second amount of additional electric power. In this architecture, the first amount of additional electric power generated by the first stage is dependent on the amount of waste heat in the primary generator exhaust, which in turn is dependent on the amount of electric power produced by the primary generator, but the second amount of additional electric power generated by the second stage is independent of that amount of power produced by the primary electric power generator. In an alternative CHP architecture, the first stage omitted, such that the remaining stage converts some of the thermal energy received from the primary generator into an amount of additional electric power that is independent of the amount of electric power produced by the primary generator.

Although the disclosure has been described as using ORC generators, it will be understood that other types of heat-to-electricity generators, such as a condensing steam turbine generator, can be used.

Although the architectures of FIGS. 7 and 8 have been described in the context of the CHP generator of FIG. 3, those architectures can be implemented in other suitable contexts where thermal energy is converted into electric power. Similarly, although the architecture of FIG. 3 has been described in the context of the PGS system of FIG. 2, that architecture can be implemented in other suitable contexts where electric power and thermal energy are generated.

Although the PGS system is shown in FIG. 2 connected to a conventional electric-power generation, transmission, and distribution system via a distribution substation, in other embodiments, the PGS system is connected to the conventional system via some other means, such as via a step-up transformer.

According to an example embodiment disclosed above in reference to FIGS. 2-8, provided is an electric overlay system (e.g., FIG. 2) for an electric-power generation, transmission, and distribution (GTD) system, the electric overlay system comprising a first circuit (e.g., 11) connected to the electric-power GTD system; a first combined heat and power (CHP) generator (e.g., CHP-1) configured to generate primary electric power and thermal energy and connected to provide the primary electric power to the first circuit; and a first thermal host facility (e.g., H1) connected to receive (i) electric power from the first circuit and (ii) an amount of thermal energy from the first CHP generator, wherein the CHP generator is configured to convert an amount of excess thermal energy not used by the first thermal host facility into additional electric power and to provide the additional electric power to the first circuit.

In some embodiments of the above electric overlay system, the amount of thermal energy used by the first thermal host facility varies over time inversely with the amount of excess thermal energy; and the first CHP generator is configured to adjust over time the amount of additional electric power generated directly with the varying amount of excess thermal energy.

In some embodiments of any of the above electric overlay systems, the electrical overlay system of claim 1, comprising one or more circuits (e.g., 11-14) including the first circuit, wherein the one or more circuits are connected to: the electric-power GTD system; one or more electric-power generators (e.g., CHP-1 to CHP-8) including the first CHP generator and each connected to provide electric power to the one or more circuits; and one or more electric-power users (e.g., H1-H8, OS1-OS4) including the first thermal host facility and each connected to receive electric power from the one or more circuits.

In some embodiments of any of the above electric overlay systems, when a total amount of electric power used by the one or more electric-power users is greater than a total amount of electric power provided by the one or more electric-power generators, then additional electric power is supplied to the one or more electric-power users by the electric-power GTD system via the one or more circuits; and when the total amount of electric power used by the one or more electric-power users is less than the total amount of electric power provided by the one or more electric-power generators, then excess electric power is supplied by the one or more electric-power generators to the electric-power GTD system via the one or more circuits.

In some embodiments of any of the above electric overlay systems, the electrical overlay system comprises one or more circuits (e.g., 11-14) including the first circuit, wherein the one or more circuits are connected to: the electric-power GTD system; one or more additional CHP generators (e.g., CHP-2 to CHP-8), each connected to provide electric power to the one or more circuits; and one or more additional thermal host facilities (e.g., H2-H8), each connected to receive electric power from the one or more circuits and thermal energy from a co-located one of the one or more additional CHP generators.

In some embodiments of any of the above electric overlay systems, the one or more circuits are further connected to at least one of: one or more non-CHP electric-power generators, each connected to provide electric power to the one or more circuits, but not any thermal energy to any thermal host facility; and one or more other facilities (e.g., OS1-OS4), each connected to receive electric power from the one or more circuits, but not any thermal energy from any CHP generator.

In some embodiments of any of the above electric overlay systems, the electric-power GTD system has one or more distribution substations, each connected to its own instance of the electrical overlay system.

In some embodiments of any of the above electric overlay systems, the CHP generator (FIG. 3) comprises: a primary electric-power generator (e.g., GT-1) configured to generate an amount of primary electric power (e.g., 16) and thermal energy (e.g., 17); and a final heat recovery and conversion stage configured to convert at least some of the thermal energy from the primary electric-power generator into an amount of additional electric power (e.g., 29) independent of the amount of primary electric power.

In some embodiments of any of the above electric overlay systems, the primary electric-power generator is a gas turbine generator or a reciprocating engine generator.

In some embodiments of any of the above electric overlay systems, the final heat recovery and conversion stage is a low-temperature heat recovery and conversion stage; the CHP generator further comprises a high-temperature heat recovery and conversion stage located between the primary electric-power generator and the low-temperature heat recovery and conversion stage; the high-temperature heat recovery and conversion stage is configured to convert at least some of the thermal energy from the primary electric-power generator into a first amount of additional electric power (e.g., 24, 25) dependent on the amount of primary electric power; and the low-temperature heat recovery and conversion stage is configured to convert at least some of the thermal energy (e.g., 18) from the high-temperature heat recovery and conversion stage into a second amount of additional electric power (e.g., 29) independent of the amount of primary electric power.

In some embodiments of any of the above electric overlay systems, the final heat recovery and conversion stage comprises: a heat recovery unit (e.g., E-1B) configured to transfer at least some of the thermal energy generated by the primary electric-power generator to a cooled fluid (e.g., 27) to generate a heated fluid (e.g., 26); and a heat conversion system (e.g., LTHC) configured to convert at least some of the thermal energy in the heated fluid into the amount of additional electric power and to provide the cooled fluid.

In some embodiments of any of the above electric overlay systems, the heat conversion system (FIG. 7) comprises: an input port configured to receive the heated fluid (e.g., 26); an output port configured to provide the cooled fluid (e.g., 27); a heat accumulator (e.g., D-2A) having a first port connected to the input port and a second port connected to the output port and configured to receive, store, and provide fluid via its first and second ports; one or more heat-to-electricity generators (e.g., ORC-2 to ORC-5) connected between the first and second ports of the heat accumulator and each configured to convert at least some of the thermal energy in the heated fluid into electric power (e.g., 68) and to provide the cooled fluid; a variable-speed pump (e.g., P-7) connected between the first and second ports of the heat accumulator and configured to allow a selected amount of the heated fluid to flow through the one or more heat-to-electricity generators; and a controller (e.g., EC-1) configured to select the amount of the heated fluid flowing through the one or more heat-to-electricity generators and thereby control the amount of electric power generated by the one or more heat-to-electricity generators.

In some embodiments of any of the above electric overlay systems, the one or more heat-to-electricity generators comprise a plurality of organic Rankine cycle (ORC) generators connected in series.

According to another example embodiment disclosed above in reference to FIGS. 2-8, provided is a combined heat and power (CHP) generator (e.g., CHP-1, FIG. 3) comprising: a primary electric-power generator (e.g., GT-1) configured to generate an amount of primary electric power (e.g., 16) and thermal energy (e.g., 17); and a final heat recovery and conversion stage configured to convert at least some of the thermal energy from the primary electric-power generator into an amount of additional electric power (e.g., 29) independent of the amount of primary electric power.

In some embodiments of the above CHP generator, the final heat recovery and conversion stage is a low-temperature heat recovery and conversion stage; the CHP generator further comprises a high-temperature heat recovery and conversion stage located between the primary electric-power generator and the low-temperature heat recovery and conversion stage; the high-temperature heat recovery and conversion stage is configured to convert at least some of the thermal energy from the primary electric-power generator into a first amount of additional electric power (e.g., 24, 25) dependent on the amount of primary electric power; and the low-temperature heat recovery and conversion stage is configured to convert at least some of the thermal energy (e.g., 18) from the high-temperature heat recovery and conversion stage into a second amount of additional electric power (e.g., 29) independent of the amount of primary electric power.

In some embodiments of any of the above CHP generators, the primary electric-power generator is a gas turbine generator or a reciprocating engine generator.

In some embodiments of any of the above CHP generators, at least some of the thermal energy from the final heat recovery and conversion stage is supplied to a thermal host facility (e.g., H1) co-located with the CHP generator.

In some embodiments of any of the above CHP generators, the amount of additional electric power generated by the final heat recovery and conversion stage inversely depends on the amount of thermal energy provided to the thermal host facility.

In some embodiments of any of the above CHP generators, the final heat recovery and conversion stage comprises: a heat recovery unit (e.g., E-1B) configured to transfer at least some of the thermal energy generated by the primary electric-power generator to a cooled fluid (e.g., 27) to generate a heated fluid (e.g., 28); and a heat conversion system (e.g., LTHC) configured to convert at least some of the thermal energy in the heated fluid into the amount of additional electric power and to provide the cooled fluid.

In some embodiments of any of the above CHP generators, the heat conversion system comprises: an input port configured to receive the heated fluid (e.g., 26); an output port configured to provide the cooled fluid (e.g., 27); a heat accumulator (e.g., D-2A) having a first port connected to the input port and a second port connected to the output port and configured to receive, store, and provide fluid via its first and second ports; one or more heat-to-electricity generators (e.g., ORC-2 to ORC-5) connected between the first and second ports of the heat accumulator and each configured to convert at least some of the thermal energy in the heated fluid into electric power (e.g., 68) and to provide the cooled fluid; a variable-speed pump (e.g., P-7) connected between the first and second ports of the heat accumulator and configured to allow a selected amount of the heated fluid to flow through the one or more heat-to-electricity generators; and a controller (e.g., EC-1) configured to select the amount of the heated fluid flowing through the one or more heat-to-electricity generators and thereby control the amount of electric power generated by the one or more heat-to-electricity generators.

In some embodiments of any of the above CHP generators, the one or more heat-to-electricity generators comprise a plurality of organic Rankine cycle (ORC) generators connected in series.

According to another example embodiment disclosed above in reference to FIGS. 2-8, provided is a heat conversion system (e.g., FIG. 7, FIG. 8) comprising: an input port configured to receive a heated fluid (e.g., 26, 70); an output port configured to provide a cooled fluid (e.g., 27, 79); a heat accumulator (e.g., D-2A, D-2B) having a first port connected to the input port and a second port connected to the output port and configured to receive, store, and provide fluid via its first and second ports; one or more heat-to-electricity generators (e.g., ORC-2 to ORC-5, ORC-6 to ORC-11) connected between the first and second ports of the heat accumulator and each configured to convert at least some of the thermal energy in the heated fluid into electric power (e.g., 68, 38) and to provide the cooled fluid; a variable-speed pump (e.g., P-7, P-8) connected between the first and second ports of the heat accumulator and configured to allow a selected amount of the heated fluid to flow through the one or more heat-to-electricity generators; and a controller (e.g., EC-1, EC-2) configured to select the amount of the heated fluid flowing through the one or more heat-to-electricity generators and thereby control the amount of electric power generated by the one or more heat-to-electricity generators.

In some embodiments of the above heat conversion system, the one or more heat-to-electricity generators comprise a plurality of heat-to-electricity generators connected in series.

In some embodiments of any of the above heat conversion systems, each heat-to-electricity generator is an organic Rankine cycle (ORC) generator.

Unless explicitly stated otherwise, each numerical value and range should be interpreted as being approximate as if the word “about” or “approximately” preceded the value or range.

It will be further understood that various changes in the details, materials, and arrangements of the parts which have been described and illustrated in order to explain embodiments of this invention may be made by those skilled in the art without departing from embodiments of the invention encompassed by the following claims.

The use of figure numbers and/or figure reference labels in the claims is intended to identify one or more possible embodiments of the claimed subject matter in order to facilitate the interpretation of the claims. Such use is not to be construed as necessarily limiting the scope of those claims to the embodiments shown in the corresponding figures.

It should be understood that the steps of the exemplary methods set forth herein are not necessarily required to be performed in the order described, and the order of the steps of such methods should be understood to be merely exemplary. Likewise, additional steps may be included in such methods, and certain steps may be omitted or combined, in methods consistent with various embodiments of the invention.

Although the elements in the following method claims, if any, are recited in a particular sequence with corresponding labeling, unless the claim recitations otherwise imply a particular sequence for implementing some or all of those elements, those elements are not necessarily intended to be limited to being implemented in that particular sequence.

Reference herein to “one embodiment” or “an embodiment” means that a particular feature, structure, or characteristic described in connection with the embodiment can be included in at least one embodiment of the invention. The appearances of the phrase “in one embodiment” in various places in the specification are not necessarily all referring to the same embodiment, nor are separate or alternative embodiments necessarily mutually exclusive of other embodiments. The same applies to the term “implementation.”

The embodiments covered by the claims in this application are limited to embodiments that (1) are enabled by this specification and (2) correspond to statutory subject matter. Non-enabled embodiments and embodiments that correspond to non-statutory subject matter are explicitly disclaimed even if they fall within the scope of the claims.

What is claimed is:

1. An electric overlay system (e.g., FIG. 2) for an electric-power generation, transmission, and distribution (GTD) system, the electric overlay system comprising a first circuit (e.g., 11) connected to:
the electric-power GTD system;
a first combined heat and power (CHP) generator (e.g., CHP-1) configured to generate primary electric power and thermal energy and connected to provide the primary electric power to the first circuit; and
a first thermal host facility (e.g., H1) connected to receive (i) electric power from the first circuit and (ii) an amount of thermal energy from the first CHP generator, wherein the CHP generator is configured to convert an amount of excess thermal energy not used by the first thermal host facility into additional electric power and to provide the additional electric power to the first circuit.

2. The electric overlay system of claim 1, wherein:
the amount of thermal energy used by the first thermal host facility varies over time inversely with the amount of excess thermal energy; and
the first CHP generator is configured to adjust over time the amount of additional electric power generated directly with the varying amount of excess thermal energy.

3. The electrical overlay system of claim 1, comprising one or more circuits (e.g., 11-14) including the first circuit, wherein the one or more circuits are connected to:
the electric-power GTD system;
one or more electric-power generators (e.g., CHP-1 to CHP-8) including the first CHP generator and each connected to provide electric power to the one or more circuits; and
one or more electric-power users (e.g., H1-H8) including the first thermal host facility and each connected to receive electric power from the one or more circuits.

4. The electrical overlay system of claim 3, wherein:
when a total amount of electric power used by the one or more electric-power users is greater than a total amount of electric power provided by the one or more electric-power generators, then additional electric power is supplied to the one or more electric-power users by the electric-power GTD system via the one or more circuits; and
when the total amount of electric power used by the one or more electric-power users is less than the total amount of electric power provided by the one or more electric-power generators, then excess electric power is supplied by the one or more electric-power generators to the electric-power GTD system via the one or more circuits.

5. The electrical overlay system of claim 1, comprising one or more circuits (e.g., 11-14) including the first circuit, wherein the one or more circuits are connected to:
the electric-power GTD system;
one or more additional CHP generators (e.g., CHP-2 to CHP-8), each connected to provide electric power to the one or more circuits; and
one or more additional thermal host facilities (e.g., H2-H8), each connected to receive electric power from the one or more circuits and thermal energy from a co-located one of the one or more additional CHP generators.

6. The electrical overlay system of claim 5, wherein the one or more circuits are further connected to one or more non-CHP electric-power generators, each connected to provide electric power to the one or more circuits, but not any thermal energy to any thermal host facility.

7. The electrical overlay system of claim 1, wherein the electric-power GTD system has one or more distribution substations, each connected to its own instance of the electrical overlay system.

8. The electrical overlay system of claim 1, wherein the CHP generator (FIG. 3) comprises:
a primary electric-power generator (e.g., GT-1) configured to generate an amount of primary electric power (e.g., 16) and thermal energy (e.g., 17); and
a final heat recovery and conversion stage configured to convert at least some of the thermal energy from the primary electric-power generator into an amount of additional electric power (e.g., 29) independent of the amount of primary electric power.

9. The electric overlay system of claim 8, wherein the primary electric-power generator is a gas turbine generator or a reciprocating engine generator.

10. The electric overlay system of claim 8, wherein:
the final heat recovery and conversion stage is a low-temperature heat recovery and conversion stage;
the CHP generator further comprises a high-temperature heat recovery and conversion stage located between the primary electric-power generator and the low-temperature heat recovery and conversion stage;
the high-temperature heat recovery and conversion stage is configured to convert at least some of the thermal energy from the primary electric-power generator into a first amount of additional electric power (e.g., 24, 25) dependent on the amount of primary electric power; and
the low-temperature heat recovery and conversion stage is configured to convert at least some of the thermal energy (e.g., 18) from the high-temperature heat recovery and conversion stage into a second amount of additional electric power (e.g., 29) independent of the amount of primary electric power.

11. The electric overlay system of claim 8, wherein the final heat recovery and conversion stage comprises:
a heat recovery unit (e.g., E-1B) configured to transfer at least some of the thermal energy generated by the primary electric-power generator to a cooled fluid (e.g., 27) to generate a heated fluid (e.g., 26); and
a heat conversion system (e.g., LTHC) configured to convert at least some of the thermal energy in the heated fluid into the amount of additional electric power and to provide the cooled fluid.

12. The electric overlay system of claim 11, wherein the heat conversion system (FIG. 7) comprises:
an input port configured to receive the heated fluid (e.g., 26);
an output port configured to provide the cooled fluid (e.g., 27);
a heat accumulator (e.g., D-2A) having a first port connected to the input port and a second port connected to the output port and configured to receive, store, and provide fluid via its first and second ports;
one or more heat-to-electricity generators (e.g., ORC-2 to ORC-5) connected between the first and second ports of the heat accumulator and each configured to convert at least some of the thermal energy in the heated fluid into electric power (e.g., 68) and to provide the cooled fluid;
a variable-speed pump (e.g., P-7) connected between the first and second ports of the heat accumulator and configured to allow a selected amount of the heated fluid to flow through the one or more heat-to-electricity generators; and
a controller (e.g., EC-1) configured to select the amount of the heated fluid flowing through the one or more heat-to-electricity generators and thereby control the amount of electric power generated by the one or more heat-to-electricity generators.

13. The electric overlay system of claim 12, wherein the one or more heat-to-electricity generators comprise a plurality of organic Rankine cycle (ORC) generators.

14. A combined heat and power (CHP) generator (e.g., CHP-1, FIG. 3) comprising:
a primary electric-power generator (e.g., GT-1) configured to generate an amount of primary electric power (e.g., 16) and thermal energy (e.g., 17); and
a final heat recovery and conversion stage configured to convert at least some of the thermal energy from the primary electric-power generator into an amount of additional electric power (e.g., 29) independent of the amount of primary electric power.

15. The CHP generator of claim 14, wherein:
the final heat recovery and conversion stage is a low-temperature heat recovery and conversion stage;
the CHP generator further comprises a high-temperature heat recovery and conversion stage located between the primary electric-power generator and the low-temperature heat recovery and conversion stage;
the high-temperature heat recovery and conversion stage is configured to convert at least some of the thermal energy from the primary electric-power generator into a first amount of additional electric power (e.g., 24, 25) dependent on the amount of primary electric power; and
the low-temperature heat recovery and conversion stage is configured to convert at least some of the thermal energy (e.g., 18) from the high-temperature heat recovery and conversion stage into a second amount of additional electric power (e.g., 29) independent of the amount of primary electric power.

16. The CHP generator of claim 14, wherein the primary electric-power generator is a gas turbine generator or a reciprocating engine generator.

17. The CHP generator of claim 14, wherein at least some of the thermal energy from the final heat recovery and conversion stage is supplied to a thermal host facility (e.g., H1) co-located with the CHP generator.

18. The CHP generator of claim 17, wherein the amount of additional electric power generated by the final heat recovery and conversion stage inversely depends on the amount of thermal energy provided to the thermal host facility.

19. The CHP generator of claim 14, wherein the final heat recovery and conversion stage comprises:
a heat recovery unit (e.g., E-1B) configured to transfer at least some of the thermal energy generated by the primary electric-power generator to a cooled fluid (e.g., 27) to generate a heated fluid (e.g., 28); and
a heat conversion system (e.g., LTHC) configured to convert at least some of the thermal energy in the heated fluid into the amount of additional electric power and to provide the cooled fluid.

20. The CHP generator of claim 19, wherein the heat conversion system comprises:
an input port configured to receive the heated fluid (e.g., 26);
an output port configured to provide the cooled fluid (e.g., 27);
a heat accumulator (e.g., D-2A) having a first port connected to the input port and a second port connected to the output port and configured to receive, store, and provide fluid via its first and second ports;
one or more heat-to-electricity generators (e.g., ORC-2 to ORC-5) connected between the first and second ports of the heat accumulator and each configured to convert at least some of the thermal energy in the heated fluid into electric power (e.g., 68) and to provide the cooled fluid;
a variable-speed pump (e.g., P-7) connected between the first and second ports of the heat accumulator and configured to allow a selected amount of the heated fluid to flow through the one or more heat-to-electricity generators; and
a controller (e.g., EC-1) configured to select the amount of the heated fluid flowing through the one or more heat-to-electricity generators and thereby control the amount of electric power generated by the one or more heat-to-electricity generators.

21. The CHP generator of claim 20, wherein the one or more heat-to-electricity generators comprise a plurality of organic Rankine cycle (ORC) generators.

22. A heat conversion system (e.g., FIG. 7, FIG. 8) comprising:
an input port configured to receive a heated fluid (e.g., 26, 70);
an output port configured to provide a cooled fluid (e.g., 27, 79);
a heat accumulator (e.g., D-2A, D-2B) having a first port connected to the input port and a second port connected to the output port and configured to receive, store, and provide fluid via its first and second ports;
one or more heat-to-electricity generators (e.g., ORC-2 to ORC-5, ORC-6 to ORC-11) connected between the first and second ports of the heat accumulator and each configured to convert at least some of the thermal energy in the heated fluid into electric power (e.g., 68, 38) and to provide the cooled fluid;
a variable-speed pump (e.g., P-7, P-8) connected between the first and second ports of the heat accumulator and configured to allow a selected amount of the heated fluid to flow through the one or more heat-to-electricity generators; and
a controller (e.g., EC-1, EC-2) configured to select the amount of the heated fluid flowing through the one or more heat-to-electricity generators and thereby control the amount of electric power generated by the one or more heat-to-electricity generators.

23. The heat conversion system of claim 22, wherein the one or more heat-to-electricity generators comprise a plurality of heat-to-electricity generators.

24. The heat conversion system of claim 22, wherein each heat-to-electricity generator is an organic Rankine cycle (ORC) generator.
